(19) United States
(12) Patent Application Publication
(10) Pub. No.: US 2018/0033118 A1
(43) Pub. Date: Feb. 1, 2018

(54) DISPLAY DEVICE, INFORMATION DISPLAY METHOD, AND COMPUTER-READABLE NON-VOLATILE STORAGE MEDIUM HAVING INFORMATION DISPLAY PROGRAM STORED THEREON

(71) Applicant: CASIO COMPUTER CO., LTD., Shibuya-ku, Tokyo (JP)

(72) Inventor: Kenzo ICHIKAWA, Kokubunji-shi, Tokyo (JP)

(73) Assignee: CASIO COMPUTER CO., LTD., Shibuya-ku, Tokyo (JP)

(21) Appl. No.: 15/550,017

(22) PCT Filed: Feb. 5, 2016
(86) PCT No.: PCT/JP2016/054208

§ 371 Date: Aug. 9, 2017

(30) Foreign Application Priority Data
Feb. 9, 2015 (JP) 2015-023220

(51) Int. Cl. G06T 3/40; G06F 1/16

(52) U.S. Cl. CPC G06T 3/40; G06F 1/163; G06F 1/1626; G06F 1/1652; G06F 1/1694; G06F 1/1643; G06T 3/20

(57) ABSTRACT

A display device equipped with a display section which has a display area extending in a direction and has a shape curved in the direction of the display area, and a control section which functions as a viewing direction setting section which sets a viewing direction of a user with respect to the display section, and an information correcting section which makes correction such that at least part of an image to be displayed in the display area is enlarged in the direction in the display area, in accordance with the set viewing direction and a curved status of the display section in the display area.

### TECHNICAL FIELD

The present invention relates to a display device, an information display method, and a computer-readable non-volatile storage medium having an information display program stored thereon.

### BACKGROUND ART

In recent years, wearable terminals capable of acquiring various biological information and physical information in exercise and daily life by being worn on a human body and providing useful information have been actively developed and commercialized. For example. Patent Document 1 discloses an aerobic exercise maintaining device which has a wristwatch-type outer appearance, detects a heart rate and moving speed by being worn on a wrist of a user, and notifies the user of various information based on the detected information by notification means or a display section.

Since this type of wearable terminal is directly worn on a body part such as a wrist or an arm, it is desired by the market and users to be thin and light weight and have a shape with a curvature in accordance with the body part where the wearable terminal is to be worn. Also, in the recent health-conscious boom and popularity of sports, high quality design and functionality are desired for wearable terminals, sportswear, goods, training machines, and the like. For example, Patent Document 2 discloses a portable device which has a thin, stylish, wristband-type outer appearance and provides various information such as time and time-count information via a display panel curved in accordance with the shape of a wrist or an arm where the portable device is to be worn.

### PRIOR ART DOCUMENTS

### Patent Documents

Patent Document 1: JP 2007-075201 A

Patent Document 2: JP 2007-078670 A

In this wristband-type wearable terminal, the display panel is provided with it being curved in accordance with the shape of a wrist or an arm where the wearable terminal is to be worn. Therefore, when a user views the display panel from a certain viewpoint, information (for example, a specific image) displayed in a display area at a front position, which is the center of the sight line, is visually recognized with a normal shape and size. On the other hand, information displayed in a display area out of the front position that is the center of the sight line is visually recognized in a distorted state.

Accordingly, among many pieces of information displayed on the display panel provided having a curved shape, the user can instantaneously grasp the contents of information near the front position with less distortion. However, since information in the display area out of the front position is distorted, it is difficult for the user to view this information and instantaneously grasp the contents of the information.

Therefore, there is a problem in that, in order to view information displayed on the curved display panel and instantaneously grasp the contents thereof, the user is required to view the display panel many times or for a longer time or required to rotate or change the orientation of a wrist or an arm where the wearable terminal has been worn, which is very burdensome and inconvenient for the user.

The present invention has been conceived in light of the above-described problem. An object of the present invention is to provide a display device, an information display method, and a computer-readable non-volatile storage medium having an information display program stored thereon by which a user can instantly and unfailingly view information displayed on a display panel having a curved shape while abbreviating a special motion.

### SUMMARY OF INVENTION

In accordance with one aspect of the present invention, there is provided a display device comprising: a display section which has a display area extending in a direction and has a shape curved in the direction of the display area; and a control section which functions as (i) a viewing direction setting section which sets a viewing direction of a user with respect to the display section, and (ii) an information correcting section which makes correction such that at least part of an image to be displayed in the display area is enlarged in the direction in the display area, in accordance with the set viewing direction and a curved status of the display section in the display area.

In accordance with another aspect of the present invention, there is provided an information display method that is performed by a control section, comprising: setting a user viewing direction with respect to a display section which has a display area extending in a direction and has a shape curved in the direction of the display area; and making correction such that at least part of an image to be displayed in the display area is enlarged in the direction in the display area in accordance with a curved status of the display section, with reference to a reference position in the display area in accordance with the set viewing direction.

In accordance with another aspect of the present invention, there is provided a non-transitory computer-readable non-volatile storage medium having stored thereon a display program that is executable by a computer for controlling a display device to actualize functions comprising: setting a user viewing direction with respect to a display section which has a display area extending in a direction and has a shape curved in the direction of the display area; and making correction such that at least part of an image to be displayed in the display area is enlarged in the direction in the display area in accordance with a curved status of the display section, with reference to a reference position in the display area in accordance with the set viewing direction.

### BRIEF DESCRIPTION OF DRAWINGS

The present invention can be more deeply understood by the detailed description below being considered together with the following drawings.

FIG. 1A to FIG. 1C are schematic structural diagrams of a first embodiment of a display device according to the present invention;

FIG. 2A to FIG. 2C are schematic diagrams showing an example of the display device according to the first embodiment when it is worn on a human body;

FIG. 3 is a schematic block diagram showing the functional structure of the display device according to the first embodiment;

FIG. 4 is an exploded perspective view showing an example of the assembly structure (inner structure) of the display device according to the first embodiment;

FIG. 5 is a flowchart of an example of user viewing direction setting processing applied in an information display method for the display device according to the first embodiment;

FIG. 6A to FIG. 6C are schematic diagrams for describing a coordinate system of the display device applied in the user viewing direction setting processing according to the first embodiment;

FIG. 7A and FIG. 7B are schematic diagrams for describing a relation between the tilt of the display device and a user viewing direction, which is applied in the user viewing direction setting processing according to the first embodiment;

FIG. 8A to FIG. 8C are schematic diagrams showing modification examples of a curvature detecting section applied in an electronic device according to the present embodiment:

FIG. 9 is a schematic block diagram showing the functional structure of a second embodiment of an electronic device including the display device according to the present invention; and

FIG. 10 is a flowchart of an example of information display processing applied in an information display method for the display device according to the second embodiment.

### DESCRIPTION OF EMBODIMENTS

Hereafter, embodiments of a display device, an information display method, and an information display program according to the present invention will be described in detail. Here, a electronic device according to the present invention has been applied in a wristband-type or bracelet-type device that is worn on a wrist of a human body.

### First Embodiment

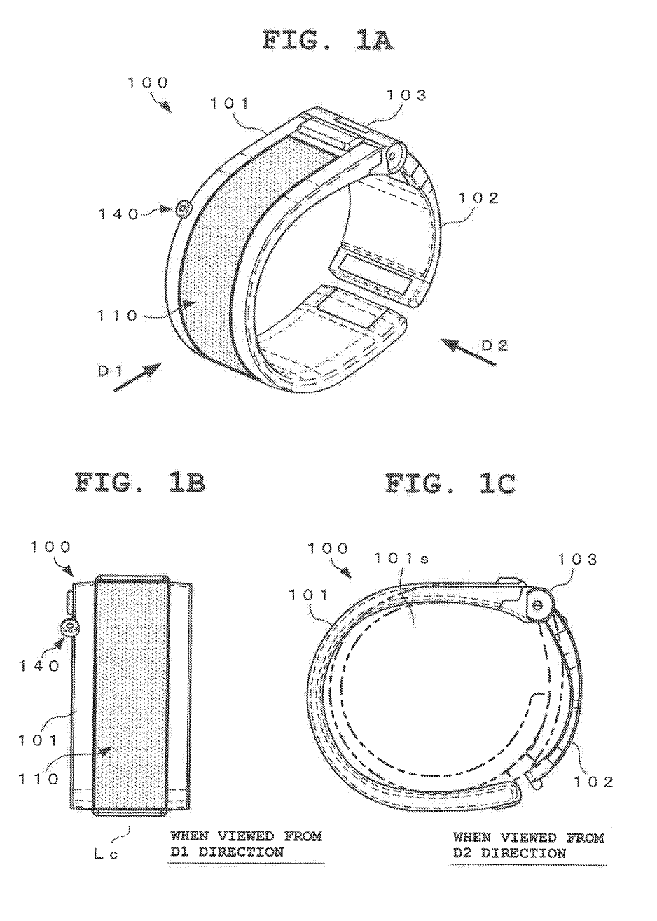

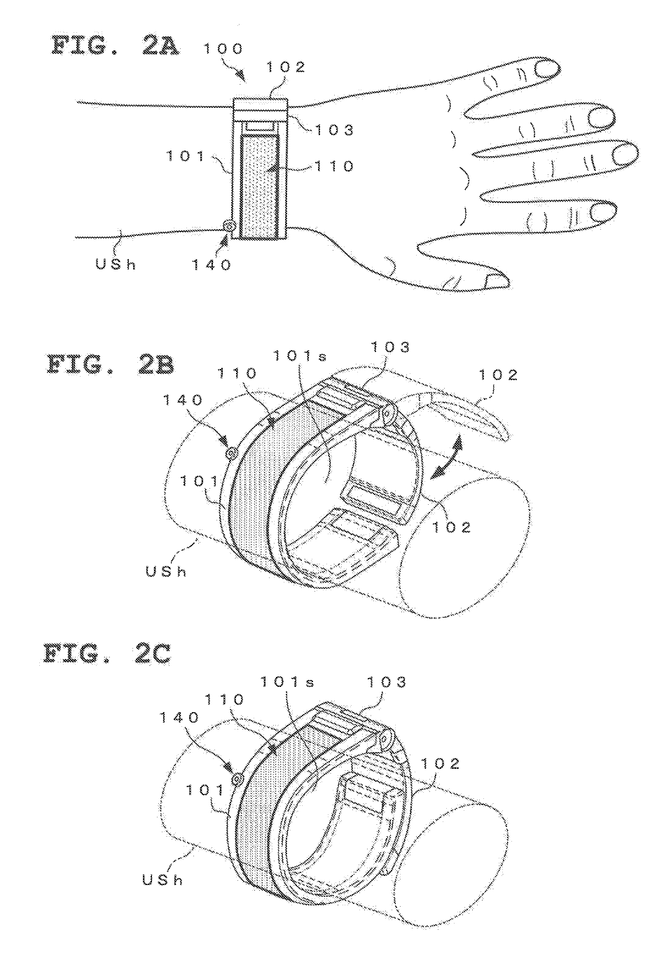

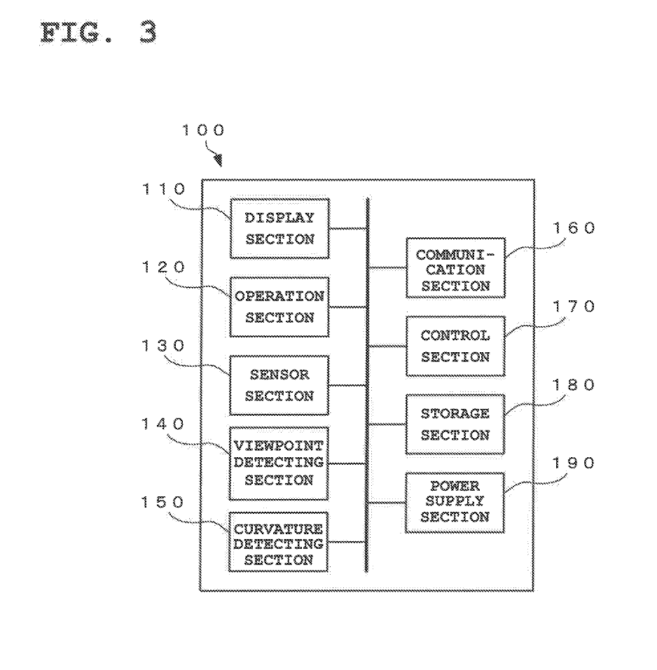

FIG. 1A to FIG. 1C are schematic structural diagrams of a first embodiment of an electronic device including a display device according to the present invention. Here, FIG. 1A is a schematic perspective view of the outer appearance of the electronic device according to the present embodiment, FIG. 1B is a front view of the electronic device depicted in FIG. 1A when viewed from a diagonally forward left direction (an arrow D1 direction), and FIG. 1C is a side view of the electronic device depicted in FIG. 1A when viewed from a diagonally forward right direction (an arrow D2 direction). Also, FIG. 2A and FIG. 2B are schematic diagrams showing an example of the electronic device according to the present embodiment when it is worn on a human body. FIG. 3 is a schematic block diagram showing the functional structure of the electronic device according to the present embodiment.

(Structure of Outer Appearance)

An electronic device 100 according to the first embodiment of the present invention has an outer appearance, for example, mainly including a device main body 101 having a curved shape when viewed from the arrow D2 direction and an opening/closing section 102 rotatably provided on the device main body 101, as depicted in FIG. 1A to FIG. 1C. Note that the device main body 101 is not necessarily required to have a specific curvature when viewed from the arrow D2 direction, and may have a polygonal shape formed of a complex of locally linear shaped short sides. Even in this case, the shape can be regarded as a substantially curved shape, and therefore this polygonal shape is also defined as a curved shape.

Specifically, the device main body 101 has a flexible and deformable structure where the curvature of a substantially-band-shaped member varies in the longitudinal direction so that it is freely curved. On one end of the device main body 101 in the longitudinal direction (end portion on the upper side in FIG. 1A and FIG. 1C), a rotating section 103 including a rotating shaft is provided.

Also, the opening/closing section 102 is constituted by a substantially-band-shaped member, and its one end (end portion on the upper side in FIG. 1A and FIG. 1C) is connected to the device main body 101 via the rotating section 103, and rotates with respect to the device main body 101 with the rotating shaft of the rotating section 103 as a pivot (center), as depicted in FIG. 1A and FIG. 1C. Accordingly, the opening/closing section 102 is designed to be changed between a closed state in which the other end (end portion on the lower side in FIG. 1A and FIG. 1C) of the opening/closing section 102 is adjacent to or in close contact with or overlaps with the other end (end portion on the lower side in FIG. 1A and FIG. 2) of the device main body 101 curved in a substantially C shape when the electronic device 100 is viewed from a side surface side (when viewed from the D2 direction depicted in FIG. 1C) and an opened state in which the other end of the opening/closing section 102 is away from the other end of the device main body 101 by a predetermined length or more.

### Worn State Example

In the above-described electronic device 100, the opening/closing section 102 is rotated with respect to the device main body 101 with the rotating shaft of the rotating section 103 as a pivot, as indicated by a two-dot-chain line in FIG. 2B, and thereby enters the opened state in which the other end of the device main body 101 curved in a substantially C shape and the other end of the opening/closing section 102 are away from each other. As a result, an attachment space 101s inside the curved portion of the device main body 101 is opened, whereby the electronic device 100 can be worn on or removed from a wrist USh.

In this opened state, when the wrist USh is inserted into the attachment space 101s of the device main body 101, and the device main body 101 is further curved along the outer periphery of the wrist USh, the opening/closing section 102 is rotated with respect to the device main body 101, and enters the closed state where the other end of the device main body 101 and the other end of the opening/closing section 102 are adjacent to or in close contact with each other, as indicated by the solid line in FIG. 2B. Alternatively, the opening/closing section 102 is wrapped around the other end of the device main body 101 and enters the closed state where the other end of the device main body 101 and the other end of the opening/closing section 102 overlap with each other, as described in FIG. 2C.

Here, the rotation of the opening/closing section 102 may be stopped by a rotation adjusting member provided to the rotating section 103, only at a position set in advance where the opening/closing section 102 enters the closed state, or may be temporarily stopped in a stepwise manner for each predetermined angle or in a non-stepwise manner. As a result, even when the thickness of the wrist USh of the user where the electronic device 100 is to be worn is varied, the attachment space 101s of the device main body 101 is defined as a circular shape in accordance with the thickness of the wrist USh, and the inner surface side (surface on the attachment space 101s side) of the device main body 101 and the opening/closing section 102 come in contact or close contact with the outer periphery of the wrist USh, whereby the electronic device 100 is worn on the wrist USh, as depicted in FIG. 1C and FIG. 2A to FIG. 2C.

Although omitted in the drawings, in the closed state indicated by the solid line in FIG. 1C, FIG. 2B, and FIG. 2C, the electronic device 100 may include a lock/unlock mechanism which connects the other end of the device main body 101 and the other end of the opening/closing section 102 which are adjacent to or in close contact with or overlap with each other, by a buckle, hook-and-loop fastener, or the like. Also, a structure may be adopted in which the other end of the device main body 101 and the other end of the opening/closing section 102 are connected in advance by an elastic member such as a rubber band. By the electronic device 100 being worn and the device main body 101 and the open/close section being locked or connected, it is possible to reliably prevent an accident in which, during use of the electronic device 100, the other end of the device main body 101 and the other end of the opening/closing section 102 become separated from each other and fall off the wrist USh.

(Functional Structure)

The electronic device 100 according to the present embodiment, for example, mainly includes a display section 110, an operation section 120, a sensor section 130, a viewpoint detecting section 140, a curvature detecting section 150, a communication section 160, a control section (curved shape obtaining section and information correcting section) 170 which is an arithmetic circuit such as a CPU, a storage section 180, and a power supply section 190, as depicted in FIG. 3. In the present embodiment, these sections are incorporated in the above-described device main body 101. Note that an example of the inner structure (assembly structure) of the device main body 101 is described later.

The display section 110, for example, is provided such that a display area extends in a band shape in a substantially center area on the outer surface side of the above-described device main body 101 which is freely curved, along the longitudinal direction of the device main body 101, as depicted in FIG. 1A, FIG. 1B, FIG. 2A, and FIG. 2B. In the band-shaped display area, various information such as current time information, biological and exercise information acquired when the user is moving or performing exercise, and arbitrary information desired by the user are displayed. In particular, in the present embodiment, processing is performed by which an image in a substantially entire display area that can be viewed from a user viewing direction is displayed in an appropriated state when viewed from the user viewing direction, with reduced distortion and deformation occurring due to the curved status of the display section 110. An example of information display on the display section 110 will be described further below. As this display section 110, various display panels can be used, such as those of a liquid-crystal type, a light-emitting-element type such as an organic EL, and an electronic paper type. Note that the display section 110 may display information in color or monochrome, and may display not only character information and still images but also moving images.

The operation section 120 has a software key, such as a touch panel (viewing direction setting section) provided on the view field side (front surface side), corresponding to the entire display area of the above-described display section 110. The touch panel is used for operations of setting information desired for display and setting a viewing direction of the user which is a direction in which the user is viewing. Note that these various setting operations by the user will be described later. Also, the operation section 120 may have a hardware key such as an operation button (push button, slide button, or touch sensor) provided on the outer surface of the device main body 101 or the opening/closing section 102, or may include both of the software key and the hardware key. The touch panel, the operation button, and the like are also used, for example, for a power supply operation for activating the electronic device 100 and an operation for setting various operations in the electronic device 100 (such as operations in the sensor section 130, the communication section 160, and the like).

The sensor section 130 has various sensors for acquiring exercise information such as acceleration and angular velocity during the movement or exercise of the user, physical information such as gravity or a geographical position, geomagnetism, and the like. Also, the sensor section 130 may have various sensors for acquiring biological information such as a pulse, body temperature, and blood pressure during the movement or exercise of the user, environmental information such as barometric pressure, air temperature, humidity, and geomagnetism, and the like. The exercise information, biological information, and the like acquired by the sensor section 130 are stored as sensor data in a predetermined storage area of the storage section 180 described later.

The viewpoint detecting section 140 has an imaging device such as a camera, and is provided near the display area of the above-described display section 110. This viewpoint detecting section 140 captures an image of the face of the user, and detects the position of a pupil in the face image (that is, the viewpoint). The position data of the viewpoint detected by the viewpoint detecting section 140 is used for processing of calculating, in the control section 170 described later, a user viewing direction Du, that is, a direction in which the user is viewing information displayed on the display section 110. Note that, in the structured depicted in FIG. 1A and FIG. 1B, one camera serving as the viewpoint detecting section 140 is arranged near the display area of the display section 110 and protrude from a side portion of the band-shaped device main body 101. However, the present invention is not limited to thereto. For example, as the viewpoint detecting section 140, a plurality of cameras may be arranged to the device main body 101 near the display area.

The curvature detecting section 150, for example, has a measuring device such as a strain gauge that detects distortion occurring due to the curve of a member to be measured, and is provided directly to the display section 110 which is curved together with the device main body 101 when the electronic device 100 is worn on the user, or is provided to a member which is curved similarly in accordance with change in the shape of the display section 110. Distortion that comes with the curve of the display section 110 is detected by the curvature detecting section 150 as voltage data, converted into a curvature by checking the voltage data against a database stored in the storage section 180 described further below, and used in the control section 170 for processing of calculating the curved status or curved shape of the display section 110. Note that the curvature detecting section 150 will be explained in the descriptions of the assembly structure.

The communication section 160 functions as an interface which transmits and receives acquired sensor data and various signals to and from a device (for example, a smartphone, tablet, or personal computer) outside the electronic device 100 and/or a network. Here, as a method for transmitting and receiving sensor data and the like from and to the electronic device 100, its external device or the like via the communication section 160, various wireless communication methods and wired communication methods can be applied. In particular, as a wireless communication method to be applied, Bluetooth (registered trademark) which is a short-distance wireless communication standard for digital devices, Bluetooth (registered trademark) low energy (LE) laid out as a low-power-consumption communication standard, NFC (Near field communication), or Wi-Fi (wireless fidelity (registered trademark)) can be favorably applied.

By executing a predetermined program, the control section 170 controls various operations such as an operation of displaying desired information on the display section 110, an information selecting operation and a display position setting operation by the operation section 120, a sensing operation by the sensor section 130, an operation of transmitting and receiving sensor data and the like by the communication section 160, and a read/write operation in the storage section 180. In particular, in the present embodiment, for an operation of displaying desired information on the display section 110, the control section 170 controls to perform an operation of detecting a user viewing direction, an operation of calculating the curved status of the display section, an operation of correcting information to be displayed on the display section 110 in accordance with the curved status of the display section 110, and an operation of displaying corrected information in a display area in a user viewing direction. This operation of displaying information on the display section 110 will be described later.

The storage section 180 stores sensor data acquired by the above-described sensor section 130, a user viewing direction detected by the viewpoint detecting section 140, a curvature detected by the curvature detecting section 150, and the curved status of the display section 110 calculated based on a curvature, and the like. Also, for the curvature detecting section 150 and the display section 110, the storage section 180 stores a relation between a curvature measured in advance and voltage data of the curvature detecting section 150, as a database. Also, the storage section 180 stores data and information for use or generated in various operations controlled by the control section 170. The storage section 180 may have stored therein a program to be executed by the control section 170. Note that the storage section 180 may be in a form of a removable storage medium such as a memory card so that it is removable from the electronic device 100.

The power supply section 190, for example, has a battery extending in a band shape along the longitudinal direction of the device main body 101 and having flexibility and deformability so as to be curved in accordance with the curved shape of the device main body 101, and supplies driving power outputted from the battery to each section of the electronic device 100. Here, as a battery to be applied in the present embodiment, for example, a secondary battery capable of being repeatedly charged and discharged may be applied, such as a lithium-ion battery or a nickel-metal-hydride battery. In this embodiment, in addition to operation of supplying driving power from the battery to each section, the power supply section 190 performs an operation of charging the battery. Note that the power supply section 190 may have a structure where a primary battery such as a commercially-available button-shaped battery or a power supply by an energy harvest technology for generating electricity by energy such as vibrations, light, heat, and electromagnetic waves is used in combination with the above-described secondary battery.

Also, although omitted in the drawings, the electronic device 100 according to the present embodiment may include, in addition to the sections depicted in FIG. 3, an acoustic section (such as a loudspeaker or buzzer) and/or a vibrating section (such as a vibrator) for giving a notification regarding information displayed on the display section 110, the operation status of the electronic device 100, and the like. As a result, various sounds such as a buzzer sound and vibrations can be generated to notify the user in accordance with display on the display section 110, the operation status (for example, when an input operation is performed by the user, when an abnormal state occurs, or the like) of the electronic device 100, or the like.

(Assembly Structure)

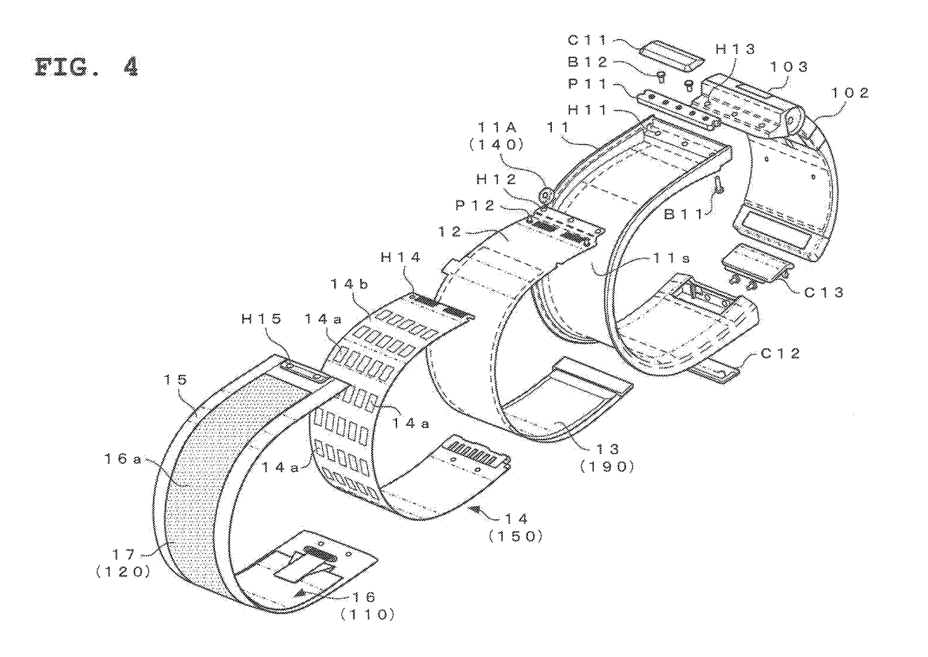

FIG. 4 is an exploded perspective view showing an example of the assembly structure (inner structure) of the electronic device according to the present embodiment.

The device main body 101 having the outer appearance depicted in FIG. 1A to FIG. 1C, for example, mainly includes a main body case 11, a circuit board 12, a battery 13, a curvature detecting section 14, an exterior cover 15, a display panel 16 having a displayable area as an area capable of displaying information provided on the entire surface, and a touch panel 17, as depicted in FIG. 4. Here, the battery 13 corresponds to the power supply section 190 depicted in FIG. 3, the curvature detecting section 14 corresponds to the curvature detecting section 150 depicted in FIG. 3, the display panel 16 corresponds to the display section 110 depicted in FIG. 3, and the touch panel 17 corresponds to the operation section 120 depicted in FIG. 3. The device main body 101 has a structure in which the circuit board 12, the battery 13, the curvature detecting section 14, and the display panel 16 are accommodated in an accommodation space 11s formed by the main body case 11 and the exterior cover 15 which closes the main body case 11.

The main body case 11 is formed of a substantially-band-shaped insulating member, and has a structure where both side portions are continuously bent or project outward (in the exterior cover 15 direction in FIG. 4) along the longitudinal direction of the band shape and the accommodation space 11s having a recessed cross section is provided. Also, the main body case 11 is formed to be freely curved by the curvature being varied in the longitudinal direction of the band-shaped member. Furthermore, at a predetermined position of one side (side portion) of the main body case 11, a camera (viewing direction setting section) 11A serving as the viewpoint detecting section 140 is provided. Still further, in the main body case 11, at least at one end (end portion on the upper side in FIG. 4) of the band-shaped member in the longitudinal direction, a plurality of mount holes H11 for connection to the rotating section 103 on the opening/closing section 102 side is provided. Note that the main body case 11 should preferably be capable of retaining the shape of the accommodation space 11s to some extent while allowing deformation so that the main body case 11 comes in contact or close contact with the wrist USh along its outer periphery when the electronic device 100 having at least the circuit board 12, the curvature detecting section 14, and the exterior cover 15 mounted in the main body case 11 is worn on the user. Also, the main body case 11 should preferably has a texture that does not give an uncomfortable feeling when it comes in contact with a human body (skin).

The circuit board 12, for example, is formed of a film-shaped insulating board (such as flexible printed board (FPC)) having a band-like flat shape, and has flexibility and deformability of being curved in accordance with change in the curvature (curve) of the main body case 11, as depicted in FIG. 4. Also, in the circuit board 12, the sensor section 130, the communication section 160, the control section 170, and the storage section 180, and the like described in the above functional structure are mounted on one or both of the front and back surfaces of the insulating board. Also, at least one end (end portion on the upper side in FIG. 4) of the circuit board 12 in the longitudinal direction is provided with a plurality of mount holes H12 for assembling and fixing in the accommodation space 11s of the main body case 11. In addition, at least one end of the circuit board 12 in the longitudinal direction is provided with a board fixing pin P12 for defining an assembling position with respect to the curvature detecting section 14 described later. The circuit board 12 mounted in the main body case 11 is electrically connected to the battery 13, the curvature detecting section 14, the display panel 16, and the touch panel 17 described below, for example, at both ends of the insulating board in the longitudinal direction, and is electrically connected to the camera 11A on a side portion at a predetermined position of the insulating board.

The battery 13, for example, is structured by a battery having a lamination package made of a resin film, a thin metal package, or the like being formed in a band shape, and arranged adjacent to or integrally fixed to one surface side (main body case 11 side) of the above-described circuit board 12, as depicted in FIG. 4. This battery 13 has flexibility and deformability of being curved in accordance with change in the curvature (curve) of the circuit board 12. Here, the battery 13 may have a band-like flat shape having dimensions in accordance with, for example, a substantially entire area of the circuit board 12, or may have a flat shape in accordance with only a part of the area. An output terminal of the battery 13 mounted in the main body case 11 is electrically connected to the circuit board 12, the display panel 16, and the like, for example, at both ends of the main body case 11 in the longitudinal direction.

The curvature detecting section 14, for example, has a structure in which a plurality of strain gauges (strain meters or strain detection elements) 14a have been arranged in one or plurality of lines at predetermined intervals along the longitudinal direction on another surface side (exterior cover 15 side) of a film-shaped insulating board 14b (for example, a thin-film board such as FPC) having a shape in accordance with a substantially entire area of the flat shape of the display panel 16 described later, as depicted in FIG. 4. This curvature detecting section 14, which is arranged to be adjacent or integrally fixed to one surface side (circuit board 12 side) of the display panel 16, has flexibility and deformability of being curved in accordance with change in the curvature (curve) of the display panel 16. Also, in at least one end (an end on an upper side in FIG. 4) of the curvature detecting section 14 in the longitudinal direction, a positioning hole H14 for defining an assembling position with respect to the circuit board 12 is provided. The curvature detecting section 14 mounted in the main body case 11 is electrically connected to the circuit board 12, for example, at both ends of the insulating board 14b in the longitudinal direction. As a result, in accordance with the curve of the device main body 101 and the display panel 16 when the electronic device 100 is worn on the user, the curvature detecting section 14 outputs voltage data from each strain gauge 14a in accordance with distortion due to the curve of the insulating board 14b. The control section 170 mounted on the above-described circuit board 12 calculates the curved status of the display panel 16 based on a voltage distribution generated from the voltage data outputted from each strain gauge 14a of the curvature detecting section 14.

The exterior cover 15, for example, is formed of an insulating thin plate having a band-like flat shape, and has flexibility and deformability of being curved in accordance with change in the curvature of the above-described main body case 11, as depicted in FIG. 4. By mounting the exterior cover 15 on the above-described main body case 11, the accommodation space 11s of the main body case 11 is closed and sealed. Here, the exterior cover 15 has characteristics (such as rigidity, heat resistance, moisture resistance, and chemical resistance) by which each section accommodated in the accommodation space 11s can be protected against at least pressure from outside of the electronic device 100 (external pressure) and surrounding environments (such as temperature, humidity, and chemical agents). Also, in the present embodiment, the exterior cover 15, for example, is formed of a transparent resin material or glass material. On one surface side (accommodation space 11s side) of the exterior cover 15, the display panel 16 constituting the display section 110 is integrally provided. Also, on the other surface side (user view field side) of the exterior cover 15, the transparent touch panel 17 constituting the operation section 120 is integrally provided. Furthermore, in the exterior cover 15, a plurality of mount holes H15 for closing the accommodation space 11s of the main body case 11 are provided in both ends (ends on the upper and lower sides in FIG. 4) of the band-shaped thin plate in the longitudinal direction.

The display panel 16, for example, has a thin display device having a band-like flat shape, is integrally provided on one surface side (accommodation space 11s side) of the above-described exterior cover 15, and has flexibility and deformability of being curved in accordance with a change of the curvature of the exterior cover 15, as depicted in FIG. 4. For this display panel 16, for example, a display device that can maintain display even if it is being warped or deformed is adopted, such as a liquid-crystal display panel having liquid crystal filled between flexible film resin boards, an organic EL display panel in which an organic EL layer is provided to a flexible film resin board, and an electronic paper display panel having color particles filled between flexible film resin boards. The display panel 16 may have one or a plurality of types of display devices such as the above-described liquid-crystal display panel, organic EL display panel, and electronic paper display panel, or may have one or a plurality of display devices of the respective types. This display panel 16 has a display area 16a extending in the longitudinal direction of the band shape. In the entire or part of the display area 16a, various types of information are displayed as characters, still images, and moving images. The information displayed on the display area 16a is visually recognized by being transmitted to the user view field side through the transparent exterior cover 15. Although omitted in the drawings, for example, at one end of the display panel 16 or the exterior cover 15 in the longitudinal direction, a driver IC for driving the display panel 16 is provided. The display panel 16 and the driver IC are electrically connected to the circuit board 12, the battery 13, and the like with the exterior cover 15 being mounted on the main body case 11.

The touch panel 17, for example, is integrally provided on the other surface side (user view field side) of the above-described exterior cover 15 and in an area corresponding to the display area 16a of the display panel 16, and has flexibility and deformability of being curved in accordance with change in the curvature of the exterior cover 15, as depicted in FIG. 4. The user performs various settings by operating the touch panel 17 based on information displayed on the display area 16a of the display panel 16 and viewed via the transparent exterior cover 15.

The opening/closing section 102 has a structure in which, for example, the rotating section 103 is provided at one end (end portion on the upper side in FIG. 4) of the substantially-band-shaped member in the longitudinal direction, as depicted in FIG. 4. The rotating section 103 includes a rotating shaft, and formed such that the opening/closing section 102 rotates with the rotating shaft as a pivot. This rotating section 103 is provided with a plurality of mount holes H13 for connection with at least the device main body 101.

In this assembly method for the electronic device, the positions of the mount holes H13 provided in the rotating section 103, the mount holes H11 provided in the main body case 11, and the mount holes H12 provided in the circuit board 12 are aligned, and male screws B11 are inserted from the inner side of the main body case 11 and the rotating section 103 (on the attachment space 101s side) so as to be screwed into female screws provided on a holder P11 for fixation, as depicted in FIG. 4.

Next, a board fixing pin P12 provided on the circuit board 12 is fitted into the positioning hole H14 provided in the curvature detecting section 14 to define the mounting position of the curvature detecting section 14 with respect to the circuit board 12. Then, both ends of the circuit board 12 and the curvature detecting section 14 in the longitudinal direction are bonded and fixed, for example, with an adhesive, double-sided adhesive tape, or the like. As a result, the circuit board 12 and the battery 13 and the curvature detecting section 14 integrally provided to the circuit board 12 are mounted in the accommodation space 11s of the main body case 11. Also, here, at an end of the circuit board 12 in the longitudinal direction, the circuit board 12 and the curvature detecting section 14 are electrically connected. Note that, as a method for positioning and fixing the circuit board 12 and the curvature detecting section 14, a method of fixing with screws, a method of welding with resin, or a hot melt method can be adopted, in addition to the method using an adhesive or double-sided adhesive tape.

Next, the exterior cover 15 having the display panel 16 and the touch panel 17 integrally provided thereon is arranged to close the accommodation space 11s of the main body case 11, and male screws B12 are inserted from the outer side into the mount holes H15 provided in the exterior cover 15 so as to be screwed into female screws provided on the holder P11 and fixed. As a result, the accommodation space 11s of the main body case 11 where the circuit board 12, the battery 13, the curvature detecting section 14, and the display panel 16 are accommodated is sealed. Here, at an end of the exterior cover 15 ad the circuit board 12 in the longitudinal direction, the display panel 16 and the driver IC provided on the exterior cover 15 side are electrically connected to the circuit board 12 and the battery 13.

Then, a cover component C11 is mounted to cover the peripheries of the male screws B12 and the mount holes 15 used for screwing and fixing the exterior cover 15 to the main body case 11 via the holder P11. As a result, moisture intrusion and the like into the sealed accommodation space 11s of the main body case 11 is prevented, and the design quality of the electronic device 100 is enhanced. In FIG. 4, for convenience of depiction, only one of the device main body 101 to which the rotating section 103 is connected (end on the upper side in FIG. 4) has been described in detail. However, similar assembly may be performed on the other end (end on the lower side in FIG. 4) so as to fix both ends of the circuit board 12, the curvature detecting section 14, and the exterior cover 15 to the main body case 11. Note that the reference numeral C12 in FIG. 4 denotes a cover component which covers the peripheries of male screws (omitted in the drawing) for fixing the other end of the exterior cover 15 to the main body case 11, and the reference numeral C13 denotes another cover component mounted on the other end of the main body case 11.

(Information Display Method)

Next, an information display method for the electronic device according to the present embodiment is described with reference to the drawings.

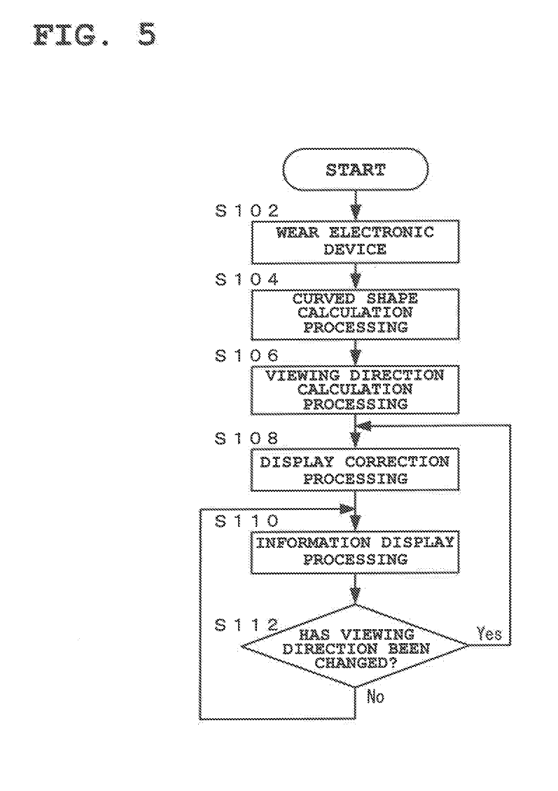

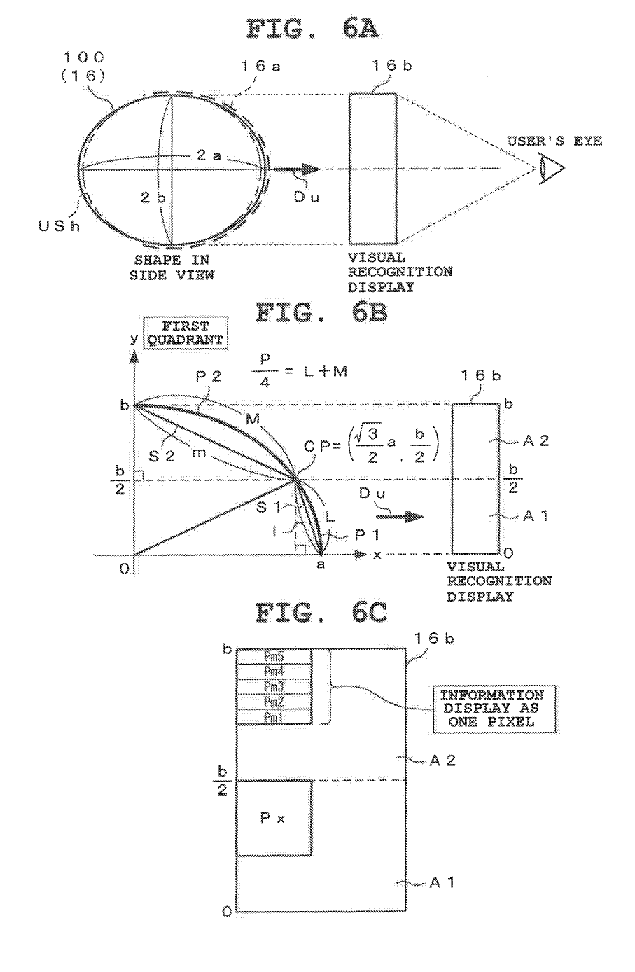

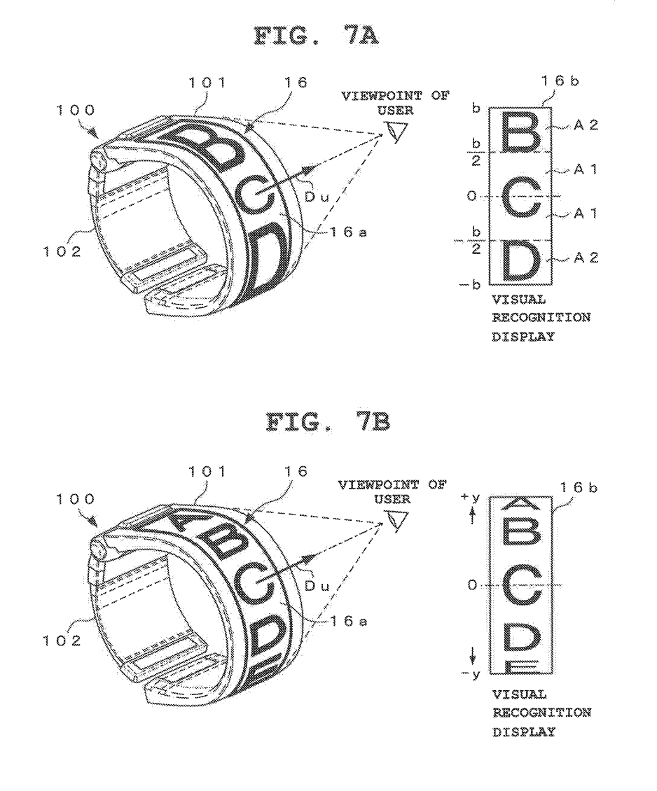

FIG. 5 is a flowchart of an example of the information display method for the electronic device according to the present embodiment. FIG. 6A to FIG. 6C are schematic diagrams for describing display correction processing applied in the information display method for the electronic device according to the present embodiment. FIG. 7A and FIG. 7B are schematic diagrams showing an example of information display achieved by the information display method according to the present invention. Here, FIG. 7A depicts a perspective view of an example of information display and a schematic diagram of visual recognition display according to the present embodiment, and FIG. 7B depicts a perspective view of an example of information display and a schematic diagram of visual recognition display in a comparative example.

In the information display method of the electronic device according to the present embodiment, curved status calculation processing, viewing direction calculation processing, display information setting processing, display correction processing, and information display processing are mainly performed. Each operation processing is achieved by the control section 170 of the electronic device 100 executing a predetermined program.

In the information display method for the electronic device 100 according to the present embodiment, first, the user wears the electronic device 100 on the body, and activates the electronic device 100 (Step S102), as depicted in FIG. 5. Note that the user may activate the electronic device 100 before wearing it. Specifically, the opening/closing section 102 is rotated with respect to the device main body 101 of the electronic device 100 so as to open the attachment space 101s, and the wrist USh is inserted into the attachment space USh, as depicted in FIG. 2B and FIG. 2C. In this state, the device main body 101 is curved along the outer periphery of the wrist USh, and the opening/closing section 102 is closed, whereby the electronic device 100 is worn on the wrist USh. Then, by the user performing an ON operation on a power supply switch (omitted in the drawings) provided on the operation section 120 of the device main body 101, driving power is supplied from the power supply section 190 to each section, whereby the electronic device 100 is activated. As a result, the control section 170 causes the sensor section 130 to start a sensing operation to acquire predetermined sensor data, and performs a series of processing (at least curved status calculation processing, viewing direction calculation processing, display correction processing, and information display processing) described below so as display desired information on the display section 110. Note that the electronic device 100 may have a configuration in which, by the battery 13 of the power supply section 190 being charged, driving power is constantly supplied from the power supply section 190 to each section so that the electronic device 100 is always in an ON state. In this case, when the electronic device 100 has not been worn, the control section 170 should preferably perform only minimum operations such as a clock display operation in the display section 110, with it being in a sleep mode in which power consumption is reduced.

Next, the control section 170 performs processing which calculates the curved shape of the display section 110 based on voltage data outputted from the curvature detecting section 150 (Step S104). Specifically, when the user wears the electronic device 100 on the body, the device main body 101 is curved along the outer periphery of the wrist USh as described above, whereby voltage data in accordance with distortion occurring to the curvature detecting section 150 by the curve of the display section 110 is outputted from each strain gauge 14a and stored in a predetermined storage area of the storage section 180. The control section 170 reads out each voltage data stored in the storage section 180, and checks against a database having data regarding a relation between a curvature measured in advance and the voltage data of each strain gauge 14a for the curvature detecting section 150 or the display panel 16 of the display section 110, and converts each voltage data into a curvature so as to generate a curvature distribution. Then, based on the curvature distribution, the control section 170 calculates the curved status or curved shape of the display panel 16 of the display section 110. Here, as described above, the curvature detecting section 150 is arranged to be adjacent to or integrally fixed to one surface side of the display panel 16 and has flexibility and deformability of being curved corresponding to change in the curvature of the display panel 16. Therefore, the curvature distribution generated by the control section 170 can be considered to define, by and large, the curved status or curved shape of the display panel 16. The calculated curved status of the display panel 16 (or the curvature distribution which defines the curved status) is stored in a predetermined storage area of the storage section 180. Note that this processing of calculating the curved status of the display section 110 may be performed only once immediately after the electronic device 100 is worn on the user, or may be performed regularly during the attachment of the electronic device 100 or repeatedly as appropriate.

Next, based on a face image of the user outputted from the viewpoint detecting section 140, the control section 170 performs processing of calculating a user viewing direction (Step S106). Specifically, the user makes a motion for viewing information displayed on the display section 110, with the electronic device 100 being worn on the user. Here, a face image of the user is captured by the camera 11A provided near the display area 16a of the device main body 101, and its face image data is stored in a predetermined storage area of the storage section 180. Then, the control section 170 reads out the face image data stored in the storage section 180, performs a predetermined image analysis, detects the position of a pupil in the face image, and calculates a user viewing direction (or position of the viewpoint of the user).

Note that the user viewing direction may be a direction of a straight line connecting the position of the pupil of the user and the position of the barycenter of the electronic device 100 in a real space. However, the definition of the viewing direction is not limited thereto, and may be related to the position of the pupil of the user and the position of the electronic device 100 in a real space. The processing of calculating a user viewing direction is now described in further detail. First, by an image captured by the camera 11A being analyzed, position coordinates of the pupil in plane coordinates are acquired in which the arrow D2 direction in FIG. 1A is one axis and the longitudinal direction where the display area 16a extends is the other axis. The user viewing direction can be converted into a numerical form based on a coordinate value on the other axis among the position coordinates of the pupil acquired as described above. However, the viewing direction calculating method is not limited thereto.

The calculated user viewing direction (or the position of the viewpoint) is stored in a predetermined storage area of the storage section 180. Note that this processing of calculating a user viewing direction may be performed as an initial setting operation immediately after the electronic device 100 is worn on the user, may be performed regularly during the attachment of the electronic device 100 or repeatedly as appropriate, or may be performed by the user operating the operation section 120 at arbitrary timing.

Next, based on the position relation between the viewpoint of the user and the curved display panel 16 judged based on the curved status of the display panel 16 described above and the user viewing direction, the control section 170 sets a display position of information to be displayed in the display area 16a on the display panel 16, and also performs processing of correcting a display shape (Step S108). Specifically, for example, an assumption is made that the shape of the display panel 16 of the electronic device 100 curved by being worn on the wrist USh of the user when viewed from a side surface side (or the shape of the wrist USh when viewed in cross section) approximates to an oval shape with a major axis 2a and a minor axis 2b, and a plurality of pixels are equally arranged in the display area 16a extending over the circumference of the oval shape, as depicted in FIG. 6A. Also, an assumption is made that the viewpoint of the user is present on the right in the drawing (+x direction in FIG. 6B described further below) and the user is viewing the display area 16a of the display panel 16 from the viewing direction Du. Here, for convenience of explanation, apparent display visually recognized by the user, specifically, display acquired by projecting the display area 16a visually recognized by the user onto a plane perpendicular to the viewing direction is defined as “visual recognition display” 16b. The control section 170 performs display correction processing and information display processing as described below so that the visual recognition display 16b of the information displayed in the display area 16a is uniform without distortion or deformation over the entire area. Among the pieces of the information displayed in the display area 16a, a position in the display area 16a of the display panel 16 where information desired to be displayed at the center of the sight line is displayed is touched by the user, whereby the information displayed at the touched position is displayed at the center of the sight line, which will be described further below.

A general equation representing a point on the circumference of the oval shape with the major axis 2a and the minor axis 2b depicted in FIG. 6A is represented by equation (11). Also, the perimeter P of the oval is generally an elliptic integral, and therefore is approximated by equation (12).

$$\begin{matrix}\frac{{x}^{2}}{{a}^{2}} + \frac{{y}^{2}}{{b}^{2}} = 1 & ( 11 ) \\ P = π \sqrt{2 \cdot ( {a}^{2} + {b}^{2} )} - \frac{1}{2.2} {( a - b )}^{2} & ( 12 )\end{matrix}$$

Here, for simplification of description, a case focusing on the arc-shaped display panel 16 in a first quadrant of the oval is described, in which the visual recognition display 16b corresponding to the display area 16a is equally divided into two in a y axis direction (vertical direction in the drawing), as depicted in FIG. 6B. In this case, a y coordinate at the boundary which equally divides the visual recognition display 16b into two is y=b/2 (b represents a semi-minor axis of the oval), and a point on the arc corresponding to the boundary is taken as CP. Also, y=0 represents a position serving as a center (center of the sight line) of the visual recognition display 16b visually recognized by the user as a front position of the display area 16a, and is calculated based on the curved status of the display panel 16 calculated by the above-described curved shape calculation processing and the user viewing direction Du calculated by the viewing direction calculation processing. The position of the sight line center is varied in accordance with the viewing direction Du, and may be a position corresponding to a position where a straight line connecting the position of the pupil of the user and the position the barycenter of the electronic device 100 in the real space crosses the display area of the display section 110. Note that the definition of the sight line center is not limited thereto, and may be related to a position between the position of the pupil of the user and the position of the display area in the display section 110.

Regarding the arc in the first quadrant, among the areas acquired by equally dividing the visual recognition display 16b into two, an arc P1 corresponding to an area A1 on the lower side in the drawing (y=0 to b/2) is assumed to have a length L, and an arc P2 corresponding to an area A2 on the upper side in the drawing (y=b/2 to b) is assumed to have a length M. Then, an arc length in the first quadrant is P/4=L+M. Regarding the arcs P1 and P2, lengths 1 and m of straight lines S1 and S2 connecting both ends of the arcs are represented by equations (13) and (14).

$$\begin{matrix}l = \sqrt{{( a - \frac{\sqrt{3}}{2} a )}^{2} + {( \frac{b}{2} )}^{2}} & ( 13 ) \\ m = \sqrt{{( \frac{\sqrt{3}}{2} a )}^{2} + {( \frac{b}{2} )}^{2}} & ( 14 )\end{matrix}$$

Here, the relation between the lengths L and M of the arcs P1 and P2 and the lengths l and m of the straight lines S1 and S2 can be regarded as L:M≈l:m, and therefore the lengths L and M of the arcs P1 and P2 are represented by equations (15) and (16).

$$\begin{matrix}L = \frac{l}{l + m} \frac{P}{4} = \frac{\sqrt{{( a - \frac{\sqrt{3}}{2} a )}^{2} + {( \frac{b}{2} )}^{2}} \frac{P}{4}}{\sqrt{{( \frac{\sqrt{3}}{2} a )}^{2} + {( \frac{b}{2} )}^{2}} + \sqrt{{( a - \frac{\sqrt{3}}{2} a )}^{2} + {( \frac{b}{2} )}^{2}}} & ( 15 ) \\ M = \frac{m}{l + m} \frac{P}{4} = \frac{\sqrt{{( \frac{\sqrt{3}}{2} a )}^{2} + {( \frac{b}{2} )}^{2}} \frac{P}{4}}{\sqrt{{( \frac{\sqrt{3}}{2} a )}^{2} + {( \frac{b}{2} )}^{2}} + \sqrt{{( a - \frac{\sqrt{3}}{2} a )}^{2} + {( \frac{b}{2} )}^{2}}} & ( 16 )\end{matrix}$$

Thus, a ratio M/L in the number of pixels between the areas A1 and A2 in visual recognition display 16b is represented by equation (17). That is, in the areas A1 and A2 having the same dimensions, the size (length in the y axis direction) of one pixel in the area A1 corresponds to M/L pixels in the area A2.

$$\frac{M}{L} = \frac{\sqrt{{( \frac{\sqrt{3}}{2} a )}^{2} + {( \frac{b}{2} )}^{2}}}{\sqrt{{( a - \frac{\sqrt{3}}{2} a )}^{2} + {( \frac{b}{2} )}^{2}}} \qquad ( 17 )$$

In equation (17), when the lengths of the semi-major axis a and the semi-minor axis b are acquired, the ratio M/L can be found. Here, the semi-major axis a and the semi-minor axis b are calculated based on the curved status (or a curvature distribution which defines a curved status) calculated in the above-described curved shape calculation processing (Step S104). Therefore, when substitution is made for the semi-major axis a and the semi-minor axis b into equation (17) and, for example, L=100 and M=500, the ratio M/L=5 is acquired. One pixel Px in the area A1 corresponds to five pixels in the area A2, as depicted in FIG. 6C. That is, an enlargement percentage (that is, ratio M/L) for display correction is set such that five pixels of pixels Pm1 to Pm5 in the area A2 are taken as one pixel to display one piece of information. Based on the set enlargement ratio (=five fold), the control section 170 performs enlargement processing on information (in particular, a length in the y axis direction) displayed on the display area 16a corresponding to the area A2, and makes a correction to a display shape equivalent to that of the information displayed in the area A1. Each of the areas A1 and A2 set by dividing the visual recognition display 16b, the enlargement ratio in each of the areas A1 and A2, and information corrected for each of the areas A1 and A2 are mutually associated with each other and are stored in a predetermined storage area of the storage section 180.

When the user viewing direction is a direction along the minor axis 2b in FIG. 6 (+y direction in FIG. 6B), if the visual recognition display 16b corresponding to the display area 16a is equally divided into two, an x coordinate of the boundary is x=a/2 (a represents a semi-major axis of the oval), and the coordinates of the point CP on the arc corresponding to the boundary represents (a/2, √3b/2). Thus, when arithmetic operation is performed in a manner similar to that described above, the ratio m/l is represented by equation (18).

$$\frac{m}{l} = \frac{\sqrt{{( \frac{a}{2} )}^{2} + {( b - \frac{\sqrt{3}}{2} b )}^{2}}}{\sqrt{{( \frac{a}{2} )}^{2} + {( \frac{\sqrt{3}}{2} b )}^{2}}} \qquad ( 18 )$$

Here, by regarding the ratio m/l as the ratio M/L and substituting the values of the semi-major axis a and the semi-minor axis b calculated from the curved status calculated in the curved shape calculation processing in equation (18), the value of the ratio M/L can be found. By the control section 170 enlarging information supplied to the pixels displayed on the display area 16a in accordance with the enlargement ratio, display allows appropriate visual recognition.

In the present embodiment, the visual recognition display 16b corresponding to the display area 16a is equally divided into two, as depicted in FIG. 6B. However, by performing processing of equal division into two or more areas to find an enlargement ratio for each area, as the number of divisions n is increased, finer or more continuous enlargement processing can be performed, and uniform display with further reduced distortion or deformation can be achieved over the entire area of the visual recognition display 16b in information display processing described later.

Also, in the present embodiment, display correction processing has been described in which approximation is made as an oval shape and, with reference to the reference position (y=0) serving as a sight line center set by the viewing direction calculation processing, an enlargement ratio of an area near the reference position is taken as one fold, and an area further away from this area has a higher enlargement ratio in the y axis direction. However, this method of display correction processing is merely an example, and the present invention is not limited thereto. In the present invention, for example, a method may be adopted in which the enlargement ratio of the display area 16a at and near a position where a normal line (or tangent line) with respect to a curve when the curved surface of the display panel 16 is viewed in cross section and the straight line in the viewing direction are parallel to each other (an angle θ therebetween=0 degrees (for a tangent line, the angle θ=90 degrees); which corresponding to a sight line center) is taken as one fold, and the enlargement ratio in the y axis direction becomes higher (in stages or continuously) when the angle θ becomes larger (becomes smaller for a tangent line). Here, the normal line (or tangent line) with respect to the curve when the curved surface of the display panel 16 is viewed in cross section is calculated based on the curved status (or a curvature distribution which defines the curved status) calculated in the above-described curved shape calculation processing (Step S104). In this method, information displayed on the display area 16a is enlarged, for example, with an enlargement ratio near a display area with an angle θ=30 degrees as 2/√3 (≈1.155) fold, an enlargement ratio near a display area with an angle θ=45 degrees as √2 (≈1.414) fold, and an enlargement ratio near a display area with an angle θ=60 degrees as two fold.

Next, the control section 170 causes the information corrected by the above-described display correction processing to be displayed at a predetermined position in the display area 16a on the display panel 16 (Step S110). Specifically, in the display area 16a corresponding to the area A1 near the sight line center (y=0) of the visual recognition display 16b depicted in FIG. 6A to FIG. 6C, desired information is displayed as it is without being enlarged (because the enlargement ratio is one fold), as depicted in FIG. 7A (refer to image “C” on the left in the perspective view in the drawing). On the other hand, in the display area 16a corresponding to the area A2 away from the sight line center of the visual recognition display 16b, information (corrected information) after, for example, five-fold enlargement correction of desired information in the y axis direction is displayed (refer to images “B” and “D” on the left in the perspective view in the drawing). Thus, when the user visually recognizes the information displayed on the display area 16a, the information (image “C”) displayed in the area A1 and the information (images “B” and “D”) after correction having a display shape substantially equivalent to that of the information displayed in the area A1 are visually recognized as depicted on the right in the drawing, and uniform display with reduced distortion and deformation is achieved over the entire area of the visual recognition display 16b.

For comparison, an example of information display without application of display correction according to the present embodiment is depicted in FIG. 7B, in which pieces of uncorrected information are each displayed as it is at its position in the display area 16a (refer to images “A” to “E” in the perspective view on the left in the drawing). When the user visually recognizes this display, information without distortion or deformation (image “C”) near the sight line center (y=0) of the visual recognition display 16b is visually recognized, as depicted on the right in the drawing. However, as the position moves away from the sight line center, information significantly distorted or deformed (images “A” and “E”) is visually recognized, resulting in nonuniform display.

In the display state of the corrected information described above, the control section 170 regularly or continuously monitors for the user viewing direction Du calculated at Step S106 (Step S112). When judged that there is change in the user viewing direction Du, the control section 170 returns to Step S108 to repeatedly perform the operation of setting an information display position based on the viewing direction Du newly calculated (that is, changed) and the curved status of the display panel 16 calculated in advance and enlarging the display shape to display the corrected information on the display area 16a. That is, the display position of the information (image “C”) displayed at the sight line center is changed in accordance with a change of the viewing direction Du, and the information (images “B” and “D”) displayed at a position away from the sight line center is enlarged in accordance with the curved status of the display panel. On the other hand, when judged that there is no change in the user viewing direction Du, the operation of displaying corrected information at this moment on the display area 16a continues. That is, the control section 170 calculates the viewing direction Du a plurality of times and, when judged that there is a change in the calculated viewing direction Du, controls such that the information displayed before the change of the viewing direction Du without being enlarged at the center position in the display area 16a viewed from the viewing direction Du is left as it is without being enlarged even after the change of the viewing direction Du. Also, the control section 170 controls such that the information displayed before the change of the viewing direction Du by being enlarged at a position away from the center position in the display area 16a viewed from the viewing direction Du is left in the enlarged state even after the change of the viewing direction Du. Then, after the change of the viewing direction Du, the control section 170 controls such that the information displayed at the center position in the display area 16a viewed from the viewing direction Du before the change of the viewing direction Du is displayed at a center position in the display area 16a viewed from the viewing direction Du after the change. As a result of this configuration, even if the user viewing direction Du is changed, information is displayed by being enlarged with reference to the reference position serving as a sight line center of the display area 16a of the display panel 16. Therefore, desired information is displayed in a manner to constantly follow the viewpoint of the user.

Note that in Step S112, although the control section 170 judges whether the viewing direction Du calculated based on the face image of the user captured by the camera 11A has been changed, the present invention is not limited thereto. In the present invention, the tilt and/or orientation of the electronic device 100 may be monitored based on, for example, sensor data such as acceleration and angular velocity acquired by the sensor section 130 and, when the control section 170 judges that the tilt and/or orientation of the electronic device 100 has been changed, the user viewing direction may be again calculated.

Although omitted in the flowchart depicted in FIG. 5, when an input operation for interrupting or ending the processing operation during the above-described information display processing is detected or when a similar input operation or status change is detected by constantly monitoring for change in the operation status of the electronic device 100, the control section 170 forcibly ends the processing operation. Specifically, the control section 170 detects an operation of turning the power supply switch OFF by the user, a decrease in the remaining amount of battery in the power supply section 190, an anomaly of a function or application during the processing, and the like, and forcibly interrupts and ends the series of processing operations.

Next, display information setting processing applied in the above-described information display method is described. In the display information setting processing applied in the present embodiment, the user operates the operation section 120 provided on the electronic device 100 to perform processing of setting a type and contents of information to be displayed at a position (or area) serving as a sight line center of the display area 16a. Specifically, the user first operates a touch panel, push button, or the like provided in the operation section 120 of the device main body 101 to set the operation status of the electronic device 100 in a display information setting mode.

When the electronic device 100 is set in the display information setting mode, the control section 170 displays a list or icon of information displayable in the display area 16a of the display panel 16. Next, by the user directly touching or tapping, with a fingertip, the touch panel provided on the view field side in the display area 16a where the user's desired information is being displayed so as to select information, the control section 170 sets (registers) the information as display information. Then, the control section 170 sets the operation status of the electronic device 100 in a normal mode, and performs the above-described information display method. Here, when the user selects a plurality of pieces of information, the control section 170 also sets (registers) the display position or display sequence thereof (specifically, arrangement position and sequence in the extending direction of the display area 16a with reference to the reference position serving as the sight line center of the display area 16a). As a result, various information desired by the user can be displayed in the band-shaped display area 16a in any arrangement or sequence. In this display information setting processing, as information displayable in the display area 16a of the display panel 16, various information can be applied, such as a current time, biological information and exercise information acquired when the user is moving or exercising, and the like, as well as an azimuth or weather forecast at a current position, a stock price, traffic information, news flash, and the like. From among these pieces of information, the user can select desired information. Note that this display information setting processing may be performed as an initial setting operation immediately after the electronic device 100 is worn on the user, or may be performed by the user at arbitrary timing during the attachment of the electronic device 100 or during a period in which information is displayed on the display panel 16.

As described above, in the present embodiment, in the electronic device having the band-shaped display panel which is freely curved, the curved status of the electronic device and a user viewing direction with respect to the display panel are detected. Then, based on their position relation, information displayed on the display area is enlarged. Accordingly, even if the curved status of the electronic device is changed when it is worn on the user, information displayed in the display area (that is, visual recognition display) that is viewable from the viewpoint of the user is visually recognized as uniform display with reduced distortion and deformation over the entire area. Therefore, the user can instantaneously and reliably grasp the information displayed in the display area without viewing the display panel many times or for a longer time or rotating the wrist or arm.

Also, in the present embodiment, the case has been described in which a plurality of pieces of information are selected as information to be displayed on the display section 110 and arbitrary display positions and display sequence of these pieces of information are set. In this case, the plurality of pieces of information are sequentially and adjacently arranged in the extending direction of the display area 16a, with reference to a reference position serving as the sight line center of the display area 16a. Therefore, not all pieces of information set in the visual recognition display 16b may be displayed. In the present embodiment, for example, even if the user sets a series of information (images “A” to “E”) for display, the information is viewed by the user only partially (images “B” to “D” with reference to the image “C” serving as the sight line center), as depicted in FIG. 7A. Accordingly, in the present embodiment, during a period in which information is being displayed on the display panel 16 by the above-described information display processing, the touch panel provided on the view field side of the display area 16a is directly touched or tapped by the user with a fingertip for instruction or swiping. Therefore, even if desired information among a plurality of pieces of information set in advance is changed, the information can be changed to be displayed at a position serving as the sight line center of the display area 16a by the display position of the information being moved with a simple operation, and uniform display with reduced distortion and deformation over the entire area of the visual recognition display 16b can be achieved.

### Modification Examples

Next, modification examples of the electronic device and information display method according to the present embodiment are described.

(Modification Examples of Curvature Detecting Section)

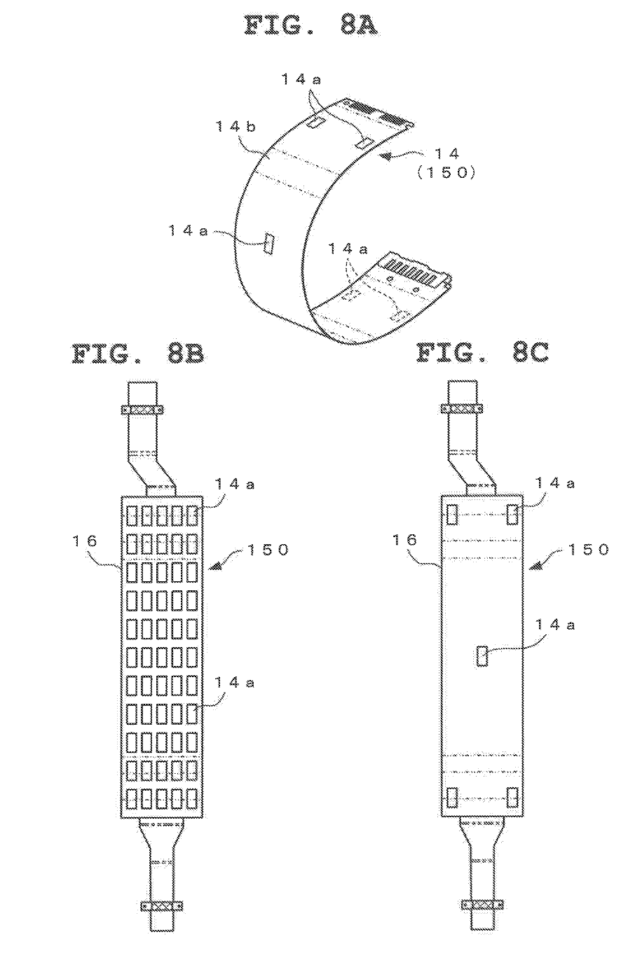

FIG. 8A to FIG. 8C are schematic diagrams showing modification examples of the curvature detecting section applied in the electronic device according to the present embodiment.

In the assembly structure of the electronic device 100 described above, as the curvature detecting section 150, the plurality of strain gauges 14a are arranged in one or a plurality of lines on the other surface side (exterior cover 15 side) of the film-shaped insulating board 14b, as depicted in FIG. 4. However, the present invention is not limited thereto, and the following modification examples may be applied.

A first modification example of the curvature detecting section, for example, has a structure in which the strain gauges 14a are arranged in five areas including four corners and the center of the insulating board 14b having a band-like flat shape, as depicted in FIG. 8A. That is, the strain gauges 14a can be arranged at any positions that enable at least the detection of distortion of the insulating board 14b which is curved in accordance with change in the curvature of the display panel 16. Unlike the structure in FIG. 4, the strain gauges 14a may not be arranged on the entire area on the other surface side of the insulating board 14b. As a result, based on voltage data outputted from each strain gauge 14a, the curved status of the display panel 16 (or a curvature distribution which defines a curved status) can be calculated. In this case as well, for the curvature detecting section 150 or the display section 110, a relation between a curvature measured in advance and voltage data of the strain gauge 14a is stored in the storage section 180 as a database and, by the detected voltage data being checked against the database, the curvature of the display panel 16 is calculated, as with the above-described embodiment.

A second modification example of the curvature detecting section has a structure in which, instead of the display panel 16 and the curvature detecting section 14 being separately formed as described above, the display panel 16 serves also as the curvature detecting section 14. Specifically, the strain gauges 14a are directly provided on the entire area on one surface side (circuit board 12 side) of the display panel 16 or in a predetermined area (for example, in five areas including four corners and the center), as depicted in FIG. 8B and FIG. 8C, respectively. That is, the strain gauges 14a may be provided at any positions as long as they can at least detect change in the curvature of the display panel 16 and, unlike the structures in FIG. 4 and FIG. 8A, the gauges 14a may not be arranged on the insulating board 14b specially provided for the curvature detecting section 150. As a result, based on voltage data outputted from each strain gauge 14a provided to the display panel 16, the curved status of the display panel 16 can be calculated. Also, since no insulating board is required as the curvature detecting section 150, the number of members constituting the electronic device 100 can be reduced and whereby the manufacturing cost can be reduced. In addition, the thickness of the device main body 101 can be made thin, whereby the degree of attachment and contact with respect to a human body can be improved. In this case as well, for the display section 110, a relation between a curvature measured in advance and voltage data of each strain gauge 14a is stored in advance in the storage section 180 as a database and, by the detected voltage data being checked against the database, the curvature of the display panel 16 is calculated.

In the above-described embodiment and each of the first and second modification examples, strain gauges which detect distortion occurring due to curve of the display section 110 that is a measurement target and curve of the insulating board 14b provided in the curvature detecting section 150 are applied as the curvature detecting section 150. However, the present invention is not limited thereto. That is, as the curvature detecting section 150 of the present invention, any measuring device other than the strain gauges may be applied as long as it can detect distortion or local deformation due to curve of the display section 110 or a member integrally provided in the display section 110 as an electric numerical value. Specifically, as the curvature detecting section, for example, a measuring device may be adopted which has electrodes arranged in matrix on each of the front and back surfaces of a sheet-shaped member formed of an entirely-uniform resistor or a uniform piezoelectric element and is provided so as to be curved in accordance with change in the curvature of the display panel 16 of the display section 110. By this curvature detecting section, the curved status or the curved shape of the display panel can be calculated based on a resistance value detected at each of positions where the electrodes are arranged in matrix or based on a distribution of voltage values.

(Modification Examples of Viewing Direction Setting Processing)

In the above-described information display method, the camera 11A is applied as the viewpoint detecting section 140 and the user viewing direction Du is calculated from a captured face image. However, the present invention is not limited thereto, and another method may be applied as long as the viewing direction or the position of the viewpoint of the user can be detected when information displayed on the display section 110 is viewed with the electronic device 100 being worn on the user. For example, the following modification examples may be applied.

In a first modification example of the viewing direction setting processing, angle information of the electronic device 100 or displacement information of the electronic device 100 is calculated based on sensor data acquired by a plurality of sensors provided in the sensor section 130 for acquiring the exercise status of the user and the like and, based on the acquired information, the user viewing direction is calculated. That is, generally speaking, when a person views display on the electronic device worn on his or her wrist or arm, the movement status (orientation) of the arm, such as the position, angle, or the like, is substantially constant due to a daily habit. Accordingly, for the orientation of the user when viewing display on the electronic device 100, a relation between angle and displacement information associated with the tilt or rotation of the electronic device 100 calculated based on sensor data acquired by the plurality of sensors such as an acceleration sensor, angular velocity sensor (gyro sensor), and geomagnetic sensor provided in the sensor section 130 and viewing directions at the time of the tilt or rotation is registered in advance. Then, angle information and its displacement information of the electronic device 100 calculated based on sensor data acquired by the various sensors with the electronic device 100 being worn on the user are judged based on the relation with the viewing directions registered in advance, whereby the user viewing direction Du can be calculated.

In the first modification example, various angle information of the electronic device 100 regarding the gravity direction in the orientation of the user when the user views the electronic device 100 is registered in advance, and angle information is calculated based on sensor data acquired during the attachment of the electronic device 100 for comparison, whereby whether the user is viewing the information displayed on the display panel of the electronic device 100 is judged. As a result of this configuration, in a state where the electronic device 100 has not been on the user (non-attachment state) or in a state where the user is not viewing information on the display panel (non-visually-recognizing state), the display section 110 is controlled to be in a non-display state (OFF state), whereby the power consumption of the electronic device 100 is reduced.

In a second modification example of the viewing direction setting processing, a user viewing direction is calculated based on sensor data acquired by a specific (one) sensor such as an acceleration sensor provided in the sensor section 130 for acquiring the exercise status of the user or the like and information regarding a viewing direction specified by the user operating the operating section. For example, by the user, who is in a posture of viewing display on the electronic device 100, operating the touch panel or the like and specifying a viewing direction in advance, an angle (a difference in angle between the gravity direction and the viewing direction) indicating a user viewing direction with respect to the gravity direction calculated based on acceleration data is measured and registered in advance. Then, the gravity direction is calculated based on acceleration data acquired by the acceleration sensor with the electronic device 100 being worn on the user, and the user viewing direction Du is calculated based on the gravity direction and the angle registered in advance.

As described above, in the first and second modification examples, a viewing direction when the electronic device 100 is worn on the user is calculated based on a relation between a parameter and a viewing direction calculated based on sensor data acquired by the sensor provided to the sensor section 130. Accordingly, when the position of the viewpoint of the user with respect to the electronic device 100 is changed or moved, the display position of the information can be changed in accordance with this change, or the information being displayed can be scrolled based on change in the position of the viewpoint or the tilt or rotation of the electronic device 100 (that is, in accordance with the rotation or the like of the arm by the user).

In a third modification example of the viewing direction setting processing, an angle in a general viewing direction is registered in advance as a default value (preset value), and a user viewing direction is determined based on this angle. That is, one or a plurality of postures and angles in viewing directions which are statistically taken by many people when they view information displayed on the display section 110 with the electronic device 100 being worn on them are extracted and registered in advance as default values. Then, one of the angles in the viewing directions registered as default values is selected by the user wearing the electronic device 100, whereby the viewing direction Du is set.

(Modification Example of Display Correction Processing)

In the above-described first embodiment, at Step S108, the control section 170 performs the operation of setting an information display position based on the calculated viewing direction Du and the curved status of the display panel 16 calculated in advance and enlarging the display shape so as to display the corrected information on the display area 16a. Here, as the method of enlarging the display shape, the display position of the information (image “C”) displayed at the sight line center is moved in accordance with change in the viewing direction Du, and the information (images “B” and “D”) displayed at a position away from the sight line center is enlarged in accordance with the curved status of the display panel 16. However, the method of enlarging the display shape herein is not limited thereto. For example, the control section 170 may calculate the viewing direction Du a plurality of times and, when judged that there is change in the calculated viewing direction, may control such that information displayed before the change of the viewing direction Du by being enlarged at a position in the display area 16a which is located at the center when viewed from the viewing direction Du after the change is not enlarged after the change of the viewing direction Du. Also, the control section 170 may control such that information displayed before the change of the viewing direction Du without being enlarged at a position away from the position in the display area 16a which is located at the center when viewed from the viewing direction Du after the change is enlarged after the change of the viewing direction Du. As a result, uniform display with reduced distortion and deformation is achieved over the entire area of the visual recognition display 16b while the information displayed at the sight line center is changed in accordance with change in the user viewing direction Du.

Note that the viewing direction setting methods described in the above-described embodiment and the modification examples may be applied singly or in combination. In particular, by a plurality of methods being applied in combination, the viewpoint (viewing direction) of the user can be appropriately set. In addition, even if the position of the viewpoint of the user is changed or moved, information display can follow in accordance with the amount of change or movement.

### Second Embodiment

Next, a second embodiment of the present invention is described.

In the above-described first embodiment, the device main body 101 and the display section 110 provided on the electronic device 100 are structured to be freely curved in accordance with the shape of a human body. In the second embodiment, the electronic device 100 has rigidity to the extent that a curved shape with a predetermined curvature can be retained so that the device main body 101 and the display section 110 are hardly distorted or deformed even when the electronic device 100 is worn on a human body.

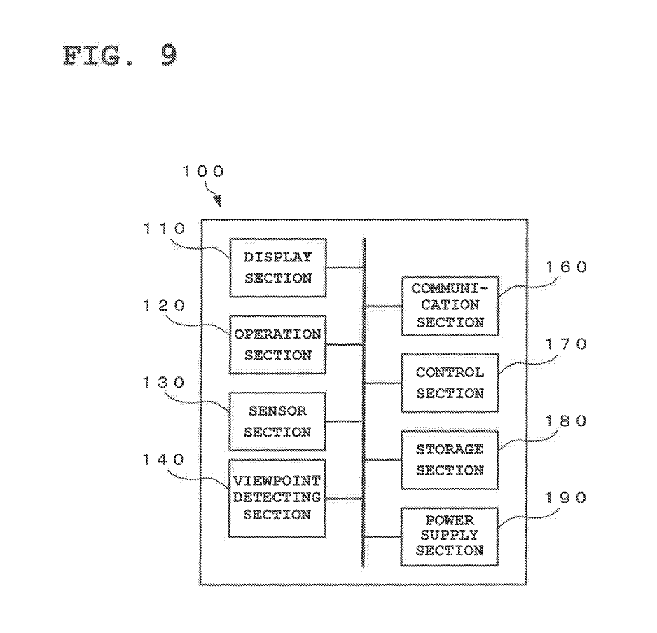

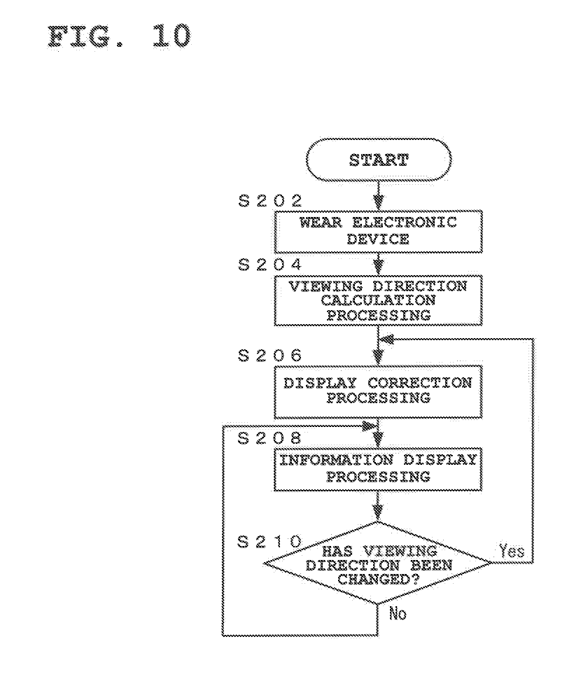

FIG. 9 is a schematic block diagram showing the functional structure of the electronic device including the display device according to the second embodiment of the present invention. FIG. 10 is a flowchart of an example of an information display method for the electronic device according to the present embodiment. Note that descriptions of structures and methods equivalent to those of the first embodiment are simplified by referring to the above descriptions as appropriate.

The electronic device 100 according to the second embodiment of the present invention has an outer appearance similar to that of the above-described first embodiment (refer to FIG. 1A to FIG. 1C). Here, the device main body 101 has a curved shape with a predetermined curvature, and has rigidity to the extent that the device main body 101 and display section 110 are hardly distorted or deformed even when the electronic device 100 is worn on a human body.

In a method of attaching the above-structured electronic device 100, for example, the opening/closing section 102 is first rotated with the rotating shaft of the rotating section 103 as a pivot so as to enter the opened state in which an end of the device main body 101 and an end of the opening/closing section 102 are separated from each other, and the wrist USh is inserted into the attachment space 101s of the device main body 101, as depicted in FIG. 2B. Then, the opening/closing section 102 is rotated with respect to the device main body 101 so as to enter the closed state in which the other end of the device main body 101 and the other end of the opening/closing section 102 are adjacent to or in close contact with each other, whereby the electronic device 100 is worn on the wrist USh.

Also, the electronic device 100 according to the present embodiment, for example, has a structure in which the curvature detecting section 150 has been omitted from the functional structure (refer to FIG. 2A to FIG. 2C) described in the first embodiment, as depicted in FIG. 9. That is, in the present embodiment, since the device main body 101 has rigidity to the extent that a curved shape with a predetermined curvature can be retained, a curvature detecting section (refer to FIG. 4) which detects distortion with the curve of the device main body 101 and the display panel 16 of the display section 110 is not provided. Also, the curved shape of the device main body 101 and the display section 110 with a predetermined curvature is stored in advance, for example, in a predetermined storage area of the storage section 180, and is used when display correction processing and information display processing applied in a series of processing of the information display method are performed.

In the information display method in the electronic device 100 according to the present embodiment, after the user wears and activates the electronic device 100 (Step S202), the viewing direction calculation processing (Step S204), the display information setting processing, the display correction processing (Step S206), the information display processing (Step S208), and the viewing direction monitoring processing (Step S210) of the processing operations described in the first embodiment are performed except the curved status calculation processing, as depicted in FIG. 10. That is, in the present embodiment, since the device main body 101 and the display panel 16 of the display section 110 have a curved shape with a predetermined curvature, the curved status calculation processing described in the first embodiment is not performed. Here, since the curved shapes of the device main body 101 and the display section 110 are stored in advance in the storage section 180, in the display correction processing, the control section 170 performs processing of setting the display position of information displayed on the display area 16a of the display panel 16 and enlarging the display shape, based on the curved shape of the display panel 16 stored in advance in the storage section 180 and a user viewing direction calculated by the viewing direction calculation processing.

According to the above-described structure and method, as with the above-described first embodiment, desired information is displayed as it is (without being enlarged) on the display area 16a corresponding to an area near the sight line center of the visual recognition display 16b, and information enlarged (corrected information) based on the position relation between the viewpoint of the user and the curved display panel 16 is displayed on the display area 16a corresponding to an area away from the sight line center of the visual recognition display 16b, as depicted in FIG. 7A. Then, by the user viewing the information displayed on the display area 16a, the information having a display shape enlarged to be substantially equivalent to that of the information displayed in the area near the sight line center is visually recognized in the area away from the sight line center in the visual recognition display 16b, whereby uniform display with reduced distortion or deformation can be achieved over the entire area of the visual recognition display 16b.

In each of the above-described embodiments, the electronic device 100 is worn on a wrist of a human body. However, the present invention is not limited thereto. That is, in the present invention, the electronic device 100 can be worn on a wrist or arm, and can also be favorably worn on a body part with a predetermined curvature (not limited to a human body) at a position which can be visually recognized by the user. Also, in the present invention, the electronic device 100 includes the device main body 101 and the opening/closing section 102, and the opening/closing section 102 is rotated with the rotating section 103 as a pivot (center) so that the electronic device 100 comes in contact or close contact with a body part so as to be worn. However, the present invention is not limited thereto. That is, in the present invention, a single band-shaped member having a continuously varied curvature may be wrapped around a human body to be worn. Alternatively, the present invention may have a polygonal shape with a plurality of flat-shaped display panels arranged at varied tilt angles when viewed from a side surface side.

This application is based upon and claims the benefit of priority from Japanese patent application No. 2015-023220, filed Feb. 9, 2015, the entire contents of which are incorporated herein by reference.

While the present invention has been described with reference to the preferred embodiments, it is intended that the invention be not limited by any of the details of the description therein but includes all the embodiments which fall within the scope of the appended claims.

1. A display device comprising:
a display section which has a display area extending in a direction and has a shape curved in the direction of the display area; and
a control section which functions as (i) a viewing direction setting section which sets a viewing direction of a user with respect to the display section, and (ii) an information correcting section which makes correction such that at least part of an image to be displayed in the display area is enlarged in the direction in the display area, in accordance with the set viewing direction and a curved status of the display section in the display area.

2. The display device according to claim 1, further comprising:
a curvature detecting section which detects a curvature that defines the curved shape of the display section; and
a curved shape obtaining section which obtains the curved shape of the display section based on distribution of the curvature.

3. The display device according to claim 2, wherein the curvature detecting section has a strain detection element that detects, as an electrical signal, distortion occurring in accordance with change in shape of the display section, and
wherein the curved shape obtaining section generates the distribution of the curvature in advance, in accordance with a correspondence relation between the electrical signal and the curvature.

4. The display device according to claim 1, wherein the control section causes the viewing direction setting section to perform setting of the viewing direction a plurality of times and, when judged that there is change in the set viewing direction, controls the information correcting section such that (i) the image displayed before the change of the viewing direction without being enlarged by the information correcting section at a center position in the display area viewed from the viewing direction is left as is without being enlarged even after the change of the viewing direction, and (ii) the image displayed before the change of the viewing direction by being enlarged by the information correcting section at a position away from the center position in the display area viewed from the viewing direction is left in an enlarged state even after the change of the viewing direction.

5. The display device according to claim 1, wherein the control section causes the viewing direction setting section to perform setting of the viewing direction a plurality of times and, when judged that there is change in the set viewing direction, functions as an information display section which displays such that, after the change of the viewing direction, the image displayed at a center position in the display area viewed from the viewing direction before the change of the viewing direction is displayed at a center position in the display area viewed from the viewing direction after the change.

6. The display device according to claim 1, wherein the control section causes the viewing direction setting section to perform setting of the viewing direction a plurality of times and, when judged that there is change in the set viewing direction, controls the information correcting section such that (i) the image displayed before the change of the viewing direction by being enlarged by the information correcting section at a center position in the display area viewed from the viewing direction after the change is not subjected to be enlarged after the change of the viewing direction, and (ii) the image displayed before the change of the viewing direction without being enlarged by the information correcting section at a position away from the position in the display area viewed from the viewing direction after the change is subjected to be enlarged after the change of the viewing direction.

7. An information display method that is performed by a control section, comprising:
setting a user viewing direction with respect to a display section which has a display area extending in a direction and has a shape curved in the direction of the display area; and
making correction such that at least part of an image to be displayed in the display area is enlarged in the direction in the display area in accordance with a curved status of the display section, with reference to a reference position in the display area in accordance with the set viewing direction.

8. The information display method according to claim 7, further comprising:
detecting a curvature that defines the curved shape of the display section; and
obtaining the curved shape of the display section based on distribution of the curvature.

9. The information display method according to claim 8, further comprising:
detecting, as an electrical signal, distortion occurring in accordance with change in shape of the display section, and
generating the distribution of the curvature in advance, in accordance with a correspondence relation between the electrical signal and the curvature.

10. The information display method according to claim 7, further comprising:
performing setting of the viewing direction a plurality of times and, when there is change in the set viewing direction, controlling such that (i) the image displayed before the change of the viewing direction without being enlarged at a center position in the display area viewed from the viewing direction is left as is without being enlarged even after the change of the viewing direction, and (ii) the image displayed before the change of the viewing direction by being enlarged at a position away from the center position in the display area viewed from the viewing direction is left in an enlarged state even after the change of the viewing direction.

11. The information display method according to claim 7, further comprising:
performing setting of the viewing direction a plurality of times and, when there is change in the set viewing direction, displaying such that, after the change of the viewing direction, the image displayed at a center position in the display area viewed from the viewing direction before the change of the viewing direction is displayed at a center position in the display area viewed from the viewing direction after the change.

12. The information display method according to claim 7, further comprising:
performing setting of the viewing direction a plurality of times and, when there is change in the set viewing direction, controlling such that (i) the image displayed before the change of the viewing direction by being enlarged at a center position in the display area viewed from the viewing direction after the change is not subjected to be enlarged after the change of the viewing direction, and (ii) the image displayed before the change of the viewing direction without being enlarged at a position away from the position in the display area viewed from the viewing direction after the change is subjected to be enlarged after the change of the viewing direction.

13. A non-transitory computer-readable non-volatile storage medium having stored thereon a display program that is executable by a computer for controlling a display device to actualize functions comprising:
setting a user viewing direction with respect to a display section which has a display area extending in a direction and has a shape curved in the direction of the display area; and
making correction such that at least part of an image to be displayed in the display area is enlarged in the direction in the display area in accordance with a curved status of the display section, with reference to a reference position in the display area in accordance with the set viewing direction.

14. The non-transitory computer-readable non-volatile storage medium according to claim 13, further comprising:
detecting a curvature that defines the curved shape of the display section; and
obtaining the curved shape of the display section based on distribution of the curvature.

15. The non-transitory computer-readable non-volatile storage medium according to claim 14, further comprising:
detecting, as an electrical signal, distortion occurring in accordance with change in shape of the display section, and
generating the distribution of the curvature in advance, in accordance with a correspondence relation between the electrical signal and the curvature.

16. The non-transitory computer-readable non-volatile storage medium according to claim 13, further comprising:
performing setting of the viewing direction a plurality of times and, when there is change in the set viewing direction, controlling such that (i) the image displayed before the change of the viewing direction without being enlarged at a center position in the display area viewed from the viewing direction is left as is without being enlarged even after the change of the viewing direction, and (ii) the image displayed before the change of the viewing direction by being enlarged at a position away from the center position in the display area viewed from the viewing direction is left in an enlarged state even after the change of the viewing direction.

17. The non-transitory computer-readable non-volatile storage medium according to claim 13, further comprising:
performing setting of the viewing direction a plurality of times and, when there is change in the set viewing direction, displaying such that, after the change of the viewing direction, the image displayed at a center position in the display area viewed from the viewing direction before the change of the viewing direction is displayed at a center position in the display area viewed from the viewing direction after the change.

18. The non-transitory computer-readable non-volatile storage medium according to claim 13, further comprising:
performing setting of the viewing direction a plurality of times and, when there is change in the set viewing direction, controlling such that (i) the image displayed before the change of the viewing direction by being enlarged at a center position in the display area viewed from the viewing direction after the change is not subjected to be enlarged after the change of the viewing direction, and (ii) the image displayed before the change of the viewing direction without being enlarged at a position away from the position in the display area viewed from the viewing direction after the change is subjected to be enlarged after the change of the viewing direction.
